(19) United States
(12) Patent Application Publication
(10) Pub. No.: US 2002/0044382 A1
(43) Pub. Date: Apr. 18, 2002

(54) DATA STORAGE READ/WRITE HEAD CLEANING TAPE CARTRIDGE

(76) Inventor: BRIAN D. BRONG, OAKDALE, MN (US)

Correspondence Address: ATTN ERIC D LEVINSON, IMATION CORP, LEGAL AFFAIRS, PO BOX 64898, ST PAUL, MN, 551640898

(21) Appl. No.: 09/383,698

(22) Filed: Aug. 26, 1999

(51) Int. Cl. G11B 5/41

(52) U.S. Cl. 360/128

(57) ABSTRACT

A cleaning tape cartridge for cleaning a read/write head of a tape drive. The cleaning tape cartridge includes a housing, first and second tape reels, first and second head wrap pins and a cleaning tape. The housing forms a head access window. The first and second tape reels are rotatably disposed within the housing. The first and second head wrap pins are disposed within the housing at opposite sides of the head access window, respectively. Further, each of the head wrap pins has a diameter greater than 0.125 inch (3.175 mm). The cleaning tape extends between the first and second tape reels along a tape path. With this configuration, the first and second head wrap pins maintain the cleaning tape within the head access window such that the cleaning tape is engageable by a head.

### BACKGROUND OF THE INVENTION

The present invention relates to a cleaning tape cartridge. More particularly, it relates to a cleaning tape cartridge for cleaning a read/write head of a tape drive.

Data storage tape cartridges and associated tape drives have been used for decades in the computer, audio and video fields. While other forms of media storage are also available, the data storage tape cartridge continues to be an extremely popular form of recording large volumes of information for subsequent retrieval and use.

Tape drives incorporating uniquely designed transducers, such as a magnetic read/write head, are used to record data to, and read data from, data storage tape cartridges. Due to the highly sensitive nature of the storage tape media and head, it is imperative that the head/tape interface be as clean as possible. Despite numerous design efforts to provide a clean operating environment, debris will invariably accumulate along the head. If left intact, the accumulated debris can introduce errors into data subsequently stored on the storage tape, and/or reading errors by the head. Thus, to ensure consistent, long-term performance, the tape drive, and in particular the head, must be periodically cleaned.

The most commonly employed technique for cleaning a read/write head is with a cleaning tape cartridge. Typically, the cleaning tape cartridge is virtually identical in design to the data storage tape cartridge used with a particular-styled tape drive, but replaces the storage tape media with an appropriately formulated cleaning tape. Thus, one type of cleaning tape cartridge consists generally of an outer shell or housing maintaining two tape reels, various corner guides, two head wrap pins, and a length of cleaning tape. The cleaning tape is wrapped about and extends between the two tape reels. The corner guides, in turn, articulate the cleaning tape through a defined tape path. In this regard, the tape path extends across a head access window (or cleaning zone) formed in the housing. For example, two of the corner guides are positioned at opposite sides of the head access window to direct the tape path through the head access window. Further, the two head wrap pins are positioned at opposite sides of the head access window, respectively, to define a desired head wrap angle upon subsequent engagement of the cleaning tape by the head. The generally accepted design associated with data storage tape cartridges configures and positions the head wrap pins to provide a nominal head wrap angle in the range of 11.0°-13.5°. Because the “standard” cleaning tape cartridge design corresponds with that of the data storage tape cartridge, the head wrap pins associated with the cleaning tape cartridge similarly provide a head wrap angle in the range of 11.0°-13.5°. Finally, a door is normally associated with the head access window to provide selective access to the cleaning tape.

During use, the cleaning tape cartridge is inserted into a tape drive. The door is maneuvered into an open position and the magnetic read/write head engages the cleaning tape via the head access window. The two head wrap pins cause the cleaning tape to wrap slightly about the head; once again, at a nominal head wrap angle in the range of 11.0°-13.5°. The tape reels are then rotated, causing the cleaning tape to ride along the head. Any contacted debris adheres to the cleaning tape and is removed from the head.

Alternatively, the cleaning tape cartridge may assume a single tape reel form, identical in design to available single-reel data storage tape cartridges. For example, the single reel cleaning tape cartridge may include a cleaning tape wound around and extending from a single tape reel. A leading end of the cleaning tape is attached to a leader block that is extendable from the cartridge housing. Following insertion of the cartridge into a tape drive, a tape drive mechanism engages the leader block, directing the leader block, and thus the storage tape, into contact with a read/write head. In this regard, the tape drive is internally configured to direct the tape (i.e., either data storage tape or cleaning tape) through a defined tape path. The tape path is normally defined by at least two internal corner guides (or D-bearings) positioned at opposite sides of the head. As with the dual-reel tape cartridge described above, the two internal corner guides position the tape such that a head wrap angle in the range of 11.0°-13.5° is achieved upon engagement of the head with the tape.

Unfortunately, while the cleaning tape cartridges described above remove debris directly contacted by the cleaning tape, relatively large amounts of debris formed along the head are not contacted by the cleaning tape, and therefore are not removed. For example, tape drive heads are commonly configured to include a central region and opposing outer regions. The central region defines a primary radius and includes MR elements, whereas the outer regions each form a secondary radius smaller than the primary radius. As a point of reference, data storage tape cartridges and/or internal corner guides are configured to position the associated storage tape so as to engage or contact the central region of the head (or wrap about the primary radius). Because cleaning tape cartridges are similarly designed, the cleaning tape will also engage or ride along only the central region, thereby removing debris generated at this area of the head. However, additional debris also forms along the outer regions, due to the movement of storage tape along the head that directs the debris to the outer regions. As the cleaning tape cartridge and/or internal corner guides do not wrap the cleaning tape into contact with the outer regions of the head, this debris builds over time, even with repeated cleaning tape cartridges uses. Simply stated, a cleaning tape cartridge and/or internal tape path configured to provide a head wrap angle in the range of 11.0°-13.5° (as is found with standard data storage tape cartridges and/or internal tape paths) will not remove debris formed at the outer regions of the head.

Cleanliness of the tape drive read/write head plays a vital role in overall tape drive performance. To this end, cleaning tape cartridges provide the most convenient and consistent means for accomplishing requisite cleaning. Unfortunately, however, the standard cleaning tape cartridge design does not facilitate contact between the cleaning tape and all regions of the head. Additionally, while brushes may be available, these brushes only remove loose debris and will wear over time. Therefore, a need exists for a cleaning tape cartridge and/or internal tape path configured to provide a head wrap angle sufficient for contacting outer regions of the head.

### SUMMARY OF THE INVENTION

One aspect of the present invention relates to a cleaning tape cartridge for cleaning a read/write head of a tape drive. The cleaning tape cartridge includes a housing, first and second tape reels, first and second head wrap pins and a cleaning tape. The housing forms a head access window. The first and second tape reels are rotatably disposed within the housing. The first and second head wrap pins are disposed within the housing at opposite sides of the head access window, respectively. In this regard, each of the head wrap pins have a diameter greater than 0.125 inch (3.175 mm). Finally, the cleaning tape extends between the first and second tape reels along a tape path. With this in mind, the first and second head wrap pins maintain the cleaning tape within the head access window such that the cleaning tape is engageable by a head. By incorporating head wrap pins having diameters greater than 0.125 inch (3.175 mm), the cleaning tape cartridge effectuates an increased head wrap angle, thereby more thoroughly cleaning a head.

Yet another aspect of the present invention relates to a cleaning tape cartridge for cleaning a read/write head of a tape drive. The cleaning tape cartridge comprises a housing, first and second tape reels, first and second head wrap pins and a cleaning tape. The housing forms a head access window. The first and second tape reels are rotatably disposed within the housing. Similarly, the first and second head wrap pins are disposed within the housing at opposite sides of the head access window, respectively. The cleaning tape extends along a tape path between the first and second tape reels. With this in mind, the first and second head wrap pins are configured to maintain the cleaning tape within the head access window and position the cleaning tape relative to a read/write head to provide a nominal head wrap angle of at least 14.0°. In one preferred embodiment, the nominal head wrap angle is 17.5°.

Yet another aspect of the present invention relates to a method of cleaning a read/write head of a tape drive. The method includes providing a cleaning tape cartridge including a cleaning tape. The cleaning tape cartridge is inserted into a tape drive such that the head engages the cleaning tape at a nominal head wrap angle of at least 14°. Finally, the cleaning tape is driven across the head. The cleaning tape contacts unwanted debris, removing the debris from the head. In one preferred embodiment, the nominal head wrap angle of at least 14° is achieved by providing a dual-reel cleaning tape cartridge including properly sized and positioned head wrap pins for directing the cleaning tape to the desired head wrap angle. In another preferred embodiment, the cleaning tape cartridge includes a single tape reel, and the nominal head wrap angle of at least 14° is achieved by providing the tape drive with corner guides sized and positioned to direct the cleaning tape to the desire head wrap angle. Alternatively, the tape drive is programmed to move the head to the desired head wrap angle.

### BRIEF DESCRIPTION OF THE DRAWINGS

FIG. 1 is a perspective view of a cleaning tape cartridge;

FIG. 2 is a top, schematic view of a cleaning tape cartridge in accordance with the present invention, with the housing removed;

FIG. 3 is a top, schematic view of the cleaning tape cartridge of FIG. 2 engaged with a read/write head;

FIG. 4 is an enlarged, top view of a portion of FIG. 3;

FIG. 5 is an enlarged, top view of a portion of an alternative cleaning tape cartridge engaged with a read/write head; and

FIG. 6 is a top, schematic view of an alternative embodiment cleaning tape cartridge.

### DETAILED DESCRIPTION OF THE PREFERRED EMBODIMENTS

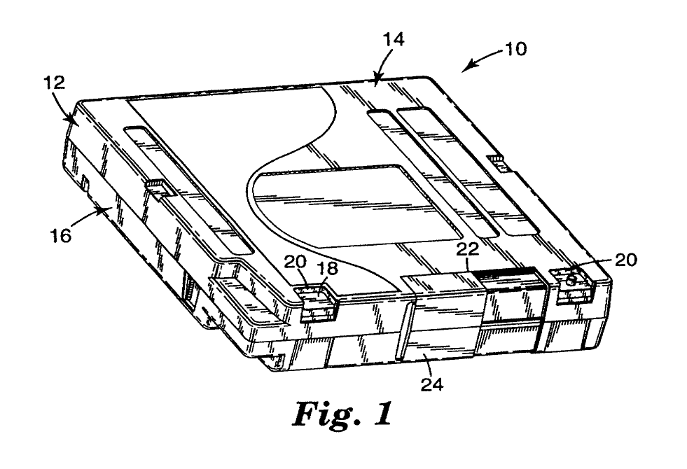

One preferred embodiment of a cleaning tape cartridge 10 is shown in FIG. 1. Generally speaking, the cleaning tape cartridge 10 includes a housing 12 defined by a first housing section 14 and a second housing section 16. The cleaning tape cartridge 10 further includes a base plate, a portion of which is preferably exposed through recesses 20 in the first housing section 14. Remaining components of the cleaning tape cartridge 10 are described in greater detail below. However, with reference to FIG. 1, it should be understood that the first housing section 14 and the second housing section 16 are reciprocally mated to one another and form an enclosure within which the various other components, including the base plate 18, are maintained.

The housing 12 is preferably sized to be received by a typical tape drive (not shown). Thus, the housing 12 may be sized for use within a 5.25 inch (130 mm) form factor drive, a 3.5 inch (90 mm) form factor drive, or other useful sizes. Further, the first housing section 14 and the second housing section 16 combine to define a head access window 22 through which cleaning tape (not shown) otherwise maintained within the housing 12 can be accessed by a read/write head (not shown). To this end, the cleaning tape cartridge 10 includes a door 24. The door 24 is preferably slidably secured to the housing 12 such that the door 24 can be selectively moved to provide access to the head access window 22. In a preferred embodiment, the first housing section 14 is a cover, whereas the second housing section 16 is a base. With reference to the orientation shown in FIG. 1, the cleaning tape cartridge 10 is normally inserted into a tape drive (not shown) with the cover 14 facing upward. It should be recognized, however, that the cleaning tape cartridge 10 can be orientated to any position. Further, the design of the cleaning tape cartridge 10 can be such that the first housing section 14 forms a base, whereas the second housing section 16 is a cover.

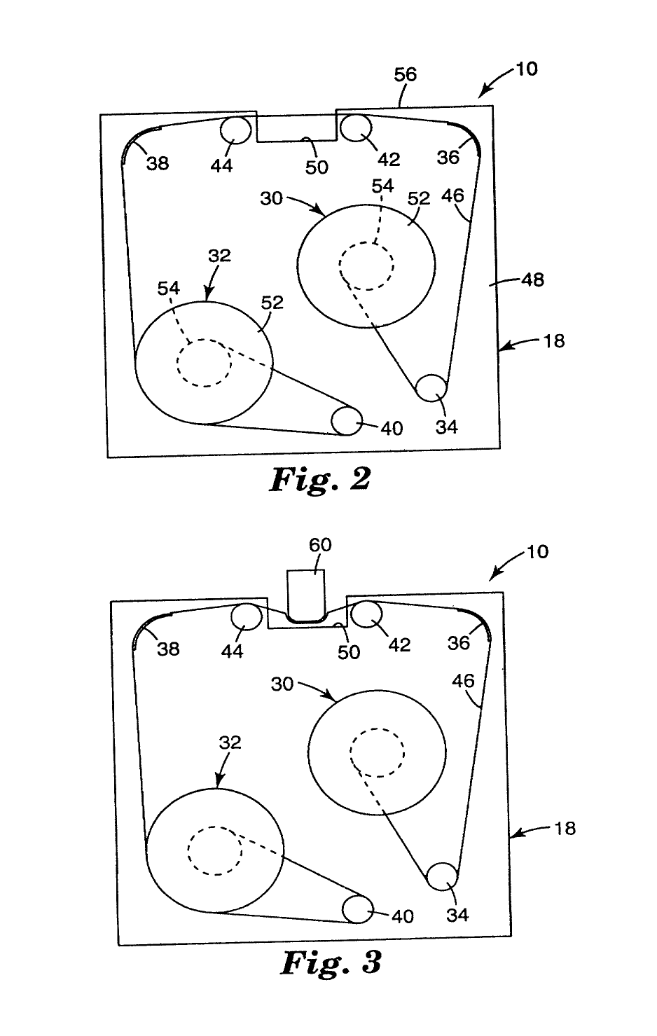

The internal components of one preferred embodiment of the cleaning tape cartridge 10 are shown schematically in FIG. 2. Notably, for ease of illustration, FIG. 2 depicts the cleaning tape cartridge 10 in an inverted position, with the first and second housing sections 14, 16 (FIG. 1) removed. With this orientation in mind, the cleaning tape cartridge 10 preferably includes the base plate 18, a first tape reel 30, a second tape reel 32, a first corner guide 34, a second corner guide 36, a third corner guide 38, a fourth corner guide 40, a first head wrap pin 42, a second head wrap pin 44 and a cleaning tape 46. As described in greater detail below, the first tape reel 30 and the second tape reel 32 are rotatably secured about respective hub pins (not shown) extending from an interior surface 48 of the base plate 18. The remaining guides 34-44 are secured to the interior surface 48 of the base plate 18.

In a preferred embodiment, the base plate 18 is made of a rigid material, such as aluminum. The base plate 18 is sized to nest within the first housing section 14 (FIG. 1), and defines a head access recess 50 corresponding with the head access window 22 (FIG. 1).

The tape reels 30, 32 are virtually identical and are positioned to rotate relative to the base plate 18 about respective hub pins (not shown). As is known in the art, each of the first and second tape reels 30, 32 includes opposing flanges 52 (one of which is shown in FIG. 2) and a central hub 54 (shown with dashed lines). The opposing flanges 52 are spaced along the hub 54 in accordance with a width or height of the cleaning tape 46. The cleaning tape 46 wraps around an outer circumference of the hub 54, laterally constrained by the opposing flanges 52.

The first, second, third and fourth corner guides 34-40 can assume a wide variety of forms and are secured to the base plate 18 as shown. For example, the first corner guide 34 and the fourth corner guide 40 are preferably large diameter pins, whereas the second corner guide 36 and the third corner guide 38 are compliant tape guides, as is known in the art. In a preferred embodiment, the compliant tape guides are secured to the base plate 18 by pins (not shown). Alternatively, the corner guides 34-40 may assume other forms, such as rollers, stationary guide surfaces, etc. Regardless, each of the corner guides 34-40 provide an arcuate tape guide surface positioned to articulate the cleaning tape 46 through a tape path. In this regard, the second and third corner guides 36, 38 direct the cleaning tape 46 through the head access recess 50 (and thus the head access window 22 (FIG. 1)).

The first and second head wrap pins 42, 44 are virtually identical in form, and are positioned at opposite sides of the head access recess 50 (and thus the head access window 22 (FIG. 1)), respectively. Each of the head wrap pins 42, 44 are preferably made from a rigid material such as aluminum. Alternatively, other rigid materials, such as stainless steel, can also be employed. In one preferred embodiment, each of the head wrap pins 42, 44 are integrally formed cylinders, having a diameter greater than 0.125 inch (3.175 mm); preferably at least 0.220 inch (5.59 mm); even more preferably at least 0.224 inch (5.69 mm). In one preferred embodiment, for ease and cost of manufacture purposes, the first and second head wrap pins 42, 44 are “standard” 0.225 inch (5.715 mm) cylindrical pins.

By selecting an appropriately sized diameter for the head wrap pins 42, 44, each of the head wrap pins 42, 44 can be positioned in close proximity to a leading end 56 of the base plate 18. It will be recalled that the base plate 18, and in particular the leading end 56, is encompassed within the housing 12 (FIG. 1). Thus, by positioning the head wrap pins 42, 44 in close proximity to the leading end 56 of the base plate 18, the head wrap pins 42, 44 are likewise positioned in close proximity to an inner edge of the housing 12. With this preferred location, the head wrap pins 42, 44 will position the cleaning tape 46 as far forward as possible (i.e., as close as possible to the leading end 56) within the head access window 22 (FIG. 1). In one preferred embodiment, an outer edge of the first head wrap pin 42 is spaced approximately 0.0625 inch (1.59 mm) from the leading end 56 of the base plate 18. This spacing is sufficient to allow passage of the cleaning tape 46, yet optimize a resulting head wrap angle as described in greater detail below.

Finally, the cleaning tape 46 is preferably a cleaning tape of a type commonly known in the art. For example, the cleaning tape 46 may consist of a flexible substrate such as polyethylene terephthalate (PET) or polyethylene naphthalate (PEN) coated with a layer of abrasive particles such as chrome dioxide, green chrome or alumina dispersed within a suitable binder system such as polyester polyurethane. Acceptable cleaning tape is available, for example, from Imation Corp. of St. Paul, Minn.

As shown in FIG. 2, the above components combine to define a tape path for the cleaning tape 46. In particular, the cleaning tape 46 extends from the first tape reel 30, and articulates about the first corner guide 34, then extending to the second corner guide 36 and the third corner guide 38. Notably, the second corner guide 36 and the third corner guide 38 maintain a lateral planar positioning of the cleaning tape 46 at the head access recess 50 (and thus the head access window 22 (FIG. 1)), with the abrasive particle side of the cleaning tape 46 facing the window 22. The head wrap pins 42, 44 are positioned at opposite sides of the head access window 22 to define a head wrap angle when the cleaning tape 46 is engaged by a head (not shown) during use, as described below. From the third corner guide 38, the cleaning tape 46 articulates about an exterior portion of the second tape reel 32, and wraps about the fourth corner guide 40. The fourth corner guide 40 directs the tape path to the second tape reel 32, where the cleaning tape 46 is wrapped about the second tape reel 32. It should be understood that the above-described tape path is but one acceptable design. That is to say, by utilizing additional or fewer of the corner guides 34-40, and/or positioning one or more of the corner guides 34-40 at different locations, an alternative tape path can be generated that sufficiently positions the cleaning tape 46 across the head access window 22.

During use, the cleaning tape cartridge 10 is inserted within a tape drive, a head 60 of which is shown in FIG. 3. For purposes of illustration, the cleaning cartridge 10 is depicted in FIG. 3 with the housing 12 (FIG. 1) removed. As a point of reference, the cleaning tape cartridge 10 is shown in FIG. 3 in an engaged positioned, whereby the head 60 contacts the cleaning tape 46 at the head access window 22. While not shown, in the engaged position, the tape reels 30, 32 are engaged by drive chucks (not shown) of the tape drive for rotating or driving the tape reels 30, 32.

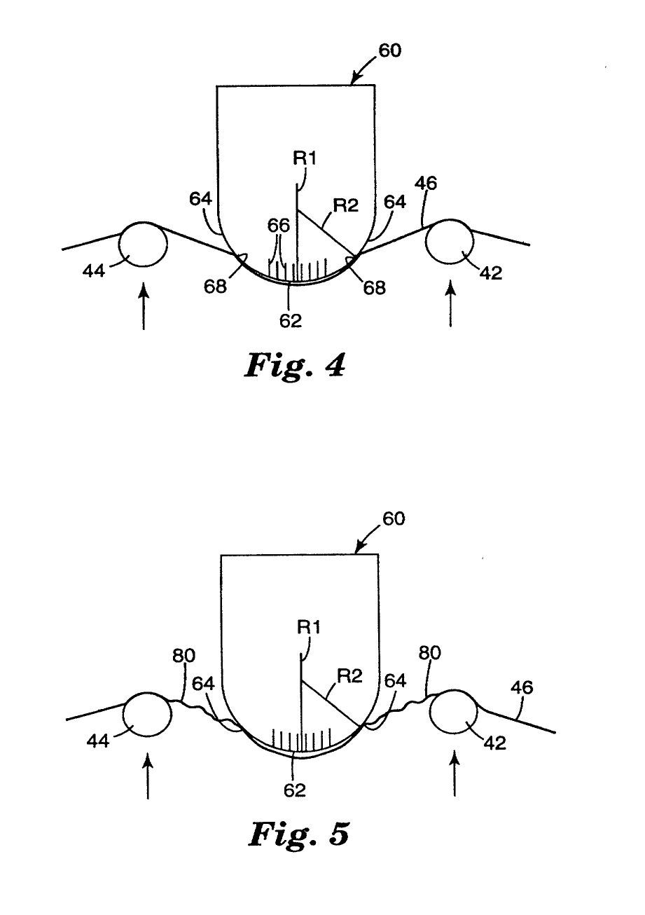

Interaction of the head 60 with the cleaning tape 46 is shown in greater detail in FIG. 4. As shown in FIG. 4, the head 60 typically defines a central region 62 and opposing, outer regions 64. The central region 62 is shown schematically as including a number of MR elements 66. The central region 62 defines a primary radius R1; whereas each of the opposing outer regions 64 define an identical secondary radius R2. While the relationship between the primary radius R1 and the secondary radius R2 has been exaggerated in FIG. 4 for purposes of illustration, the primary radius R1 is greater than the secondary radius R2. The zone of contact between the head 60 and cleaning tape 46 is defined by a head wrap angle of the cleaning tape 46 relative to the head 60. Prior art cleaning tape cartridges provided a tape path mimicking that of available data storage tape cartridges, whereby the cleaning tape contacted only the central region 62 via a head wrap angle of 11.0°-13.5°. The cleaning tape cartridge 10 of the present invention, however, directs the cleaning tape 46 relative to the head 60 at a head wrap angle of at least 14°, more preferably at least 16°, most preferably 17.5°. With this preferred head wrap angle, the cleaning tape 46 contacts significant portions of the opposing outer region 64 of the head 60, thereby removing accumulated debris 68 not otherwise accessible by currently available cleaning tape cartridges. In particular, and as is shown in FIG. 4, the enlarged head wrap pins 42, 44 position and allow the cleaning tape 46 to articulate about the head 60 at a head wrap angle of at least 14°, more preferably at least 16°, most preferably 17.5°. It will be recognized that head configurations other than the head 60 are available and can be cleaned in accordance with the present invention.

Contact of the cleaning tape 46 with the opposing outer region 64 of the head 60 can be augmented by configuring the cleaning tape cartridge 10 such that the head wrap pins 42, 44 are movable upon engagement with the tape drive (not shown). For example, the cleaning tape cartridge 10 (FIG. 1) can be configured to further include mechanisms for maneuvering the head wrap pins 42, 44 forward (relative to the leading end 56 of the base plate 18) upon engagement of the head 60 with the cleaning tape 46 (i.e., in the direction of arrows shown in FIG. 4). Forward movement of the head wrap pins 42, 44 directs the cleaning tape 46 to an even greater head wrap angle, thereby contacting additional surface area of the opposing outer regions 64 of the head 60. Even further, with this configuration, the tape drive (not shown) can be programmed to move the head wrap pins 42, 44 back and forth relative to the head 60. This back and forth movement will direct the cleaning tape 46 to selectively contact virtually all areas of the head 60 requiring cleaning. With this configuration, the head wrap pins 42, 44 may have a diameter less than or equal to 0.125 inch (3.175 mm).

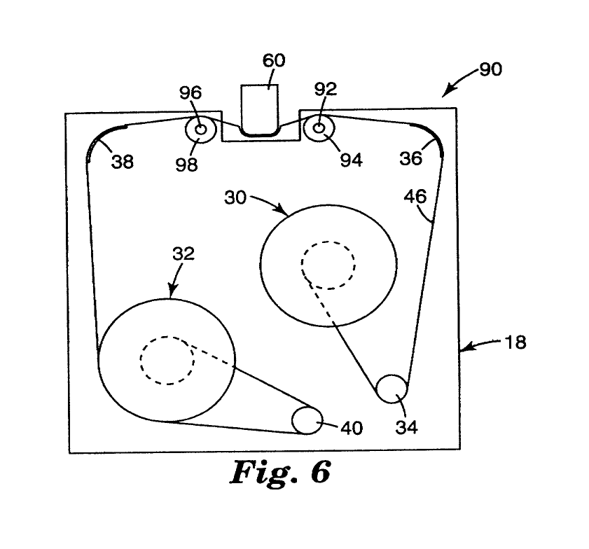

An additional alternative technique for effectuating thorough cleaning of all areas of the head 60 entails programming the tape drive (not shown) to rotate the tape reels 30, 32 (FIG. 2) at varying speeds or cycles during at least a portion of the cleaning operation. As previously described, drive chucks (not shown) of the tape drive engage and rotate the tape reels 30, 32. Rotation of the drive chucks, in turn, is controlled by a programmable microprocessor or similar control device (not shown) of the tape drive. Thus, the control device can be programmed to operate the drive chucks through a determined drive cycle upon insertion of the cleaning tape cartridge 10. The desired tape reel rotation can be generated as microcode provided or stored by the tape drive control device. With programming tape reel rotation, a slack 80 can be generated in the cleaning tape 46 as shown in FIG. 5. For example, the tape drive can be programmed to rotate the tape reels 30, 52 at different rotational speeds, thereby generating the slack 80. Alternatively, one of the tape reels 30 or 32 can be stopped while the other tape reel 30 or 32 continues to rotate, again developing the slack 80. The slack 80 in the cleaning tape 46 allows the cleaning tape 46 to assume an even greater wrap angle, thereby contacting additional portions of the opposing outer regions 64.

While the head wrap pins 42, 44 have been described as being integral, cylindrical bodies, other configurations can be employed. For example, an alternative embodiment of a cleaning tape cartridge 90 is depicted in FIG. 6. The cleaning tape cartridge 90 is highly similar to the cleaning tape cartridge 10 (FIGS. 1 and 2) previously described. As a point of reference, the cleaning tape cartridge 90 is depicted without the housing 12 (FIG. 1) for ease of illustration. With this in mind, the cleaning tape cartridge 90 incorporates many of the same components as the cleaning tape cartridge 10 (FIG. 2), including the base plate 18, the first tape reel 30, the second tape reel 32, the first corner guide 34, the second corner guide 36, the third corner guide 38, the fourth corner guide 40 and the cleaning tape 46. Further, the cleaning tape cartridge 90 includes a first head wrap pin 92, a first sleeve 94, a second head wrap pin 96 and a second sleeve 98. The cleaning tape cartridge 90 is virtually identical to a cleaning tape cartridge available from Imation Corp. of St. Paul, Minn., sold under the trade name 9840-compatible cleaning cartridge (TM), with the addition of the first sleeve 94 and the second sleeve 98. That is to say, a currently available cleaning tape cartridge includes the first and second head wrap pins 92, 96, each having a diameter of 0.125 inch (3.175 mm). As previously described with respect to the cleaning tape cartridge 10 (FIG. 2), a head wrap pin diameter of greater than 0.125 inch (3.175 mm) is required to effectuate an appropriate head wrap angle upon contact between the head 60 (FIG. 4) and the cleaning tape 46. As such, the available cleaning tape cartridge is modified or retrofitted to include the first sleeve 94 secured over the first head wrap pin 92 and the second sleeve 98 secured over the second head wrap pin 96. The sleeves 94, 98 can be secured to the respective head wrap pin 92, 96 in a variety of fashions, including frictional fit, welding, adhesives, etc. The first and second sleeves 94, 98 are preferably identical, each being formed from a rigid material such as aluminum and having an outer diameter greater than 0.125 inch (3.175 mm). More preferably, each of the first and second sleeves 94, 98 has an outer diameter greater than 0.22 inch (5.59 mm); more preferably greater than 0.224 inch (5.69 mm); most preferably an outer diameter of 0.225 inch (5.715 mm). With this configuration, the first and second sleeves 94, 98 position the cleaning tape 46 so as to provide a nominal head wrap angle of at least 14.0° upon engagement of the cleaning tape 46 with the head 60 (FIG. 4), more preferably, at least 16.0°. Most preferably, the first and second sleeves 94, 98 facilitate a nominal head wrap angle of 17.5°.

While the present invention has been described with reference to a dual-reel cleaning tape cartridge (such as the cartridge 10 of FIG. 1), the desired head wrap angle of at least 14.0°, more preferably at least 16.0°, most preferably 17.5° can also be achieved with a single-reel cleaning tape cartridge. As previously described, with a single-reel tape cartridge, the tape (such as the data storage tape or the cleaning tape) is directed from the cartridge housing by the tape drive and into contact with the head. In this regard, another aspect of the present invention provides the tape drive with internal guides configured to direct the cleaning tape though a tape path that results in the desired head wrap angle. For example, internal components of the tape drive can include D-bearing corner guides located to provide the tape path as shown in FIG. 4. Alternatively, with a single-reel cleaning tape cartridge, the tape drive can be programmed such that during a cleaning operation, the head is directed to move to a more forward position (as compared to the normal head/tape position utilized during data storage/retrieval). By increasing the head penetration, a head wrap angle of at least 14.0°, more preferably at least 16.0°, most preferably 17.5°, is achieved.

The cleaning tape cartridge and/or read/write cleaning method of the present invention provides a marked improvement over previous designs. In one preferred embodiment, by incorporating oversized head wrap pins, the cleaning tape cartridge will effectuate an increased head wrap angle between the cleaning tape and the head upon engagement therewith, as compared to previous cleaning tape cartridge designs. The increased head wrap angle, in turn, causes the cleaning tape to contact outer regions of the head not otherwise accessible by prior art cleaning tape cartridges. Thus, the cleaning tape cartridge of the present invention more thoroughly cleans the tape drive head. In one preferred embodiment, an existing cleaning tape cartridge can be modified to achieve the desired cleaning results. Alternatively, the increased head wrap angle can be achieved by programming the tape drive to maneuver the head to the desired head wrap angle.

Although the present invention has been described with reference to preferred embodiments, workers skilled in the art will recognize that changes can be made in form and detail without departing from the spirit and scope of the present invention. For example, while the preferred cleaning cartridge has been described as incorporating four corner guides, any other number, either greater or smaller, may be included. Similarly, while the cleaning tape cartridge has been described as including a base plate, alternative embodiments can be formed without a base plate. Even further, the cleaning cartridge can be a single-reel or a dual-reel cartridge.

What is claimed is:

1. A cleaning tape cartridge for cleaning a read/write head of a tape drive, the cleaning tape cartridge comprising:
a housing forming a head access window;
first and second tape reels rotatably disposed within the housing;
first and second head wrap pins disposed within the housing at opposite sides of the head access window, respectively, wherein each of the head wrap pins has a diameter greater than 0.125 inch; and
a cleaning tape extending between the first and second tape reels along a tape path;
wherein the first and second head wrap pins maintain the cleaning tape within the head access window such that the cleaning tape is engageable by a head.

2. The cleaning tape cartridge of claim 1, wherein each of the head wrap pins has a diameter of approximately 0.225 inch.

3. The cleaning tape cartridge of claim 1, wherein the head access window is formed at a forward end of the housing, and further wherein at least one of the head wrap pins is positioned to provide a spacing of less than approximately 0.0625 inch between an interior surface of the forward end of the housing and the head wrap pin.

4. The cleaning tape cartridge of claim 1, wherein the head wrap pins are configured to provide a nominal head wrap angle of greater than 14° upon engagement of the cleaning tape with a head.

5. The cleaning tape cartridge of claim 4, wherein the nominal head wrap angle is approximately 17.5°.

6. The cleaning tape cartridge of claim 1, wherein each of the head wrap pins is formed from aluminum.

7. The cleaning tape cartridge of claim 1, wherein at least one of the head wrap pins includes a sleeve secured about a central shaft.

8. A cleaning tape cartridge for cleaning a read/write head of a tape drive, the cleaning tape cartridge comprising:
a housing forming a head access window;
first and second tape reels rotatably disposed within the housing;
first and second head wrap pins disposed within the housing at opposite sides of the head access window, respectively; and
a cleaning tape extending along a tape path between the first and second tape reels;
wherein the first and second head wrap pins are configured to maintain the cleaning tape within the head access window and position the cleaning tape relative to a read/write head to provide a nominal head wrap angle of at least 14°.

9. The cleaning tape cartridge of claim 8, wherein the nominal head wrap angle is approximately 17.5°.

10. The cleaning tape cartridge of claim 8, wherein each of the head wrap pins has a diameter of greater than 0.125 inch.

11. The cleaning tape cartridge of claim 10, wherein each of the head wrap pins has a diameter of approximately 0.225 inch.

12. The cleaning tape cartridge of claim 8, wherein the head access window is formed at a forward end of the housing, and further wherein at least one of the head wrap pins is positioned to provide a spacing of less than approximately 0.0625 inch between an interior surface of the forward end of the housing and the head wrap pin.

13. The cleaning tape cartridge of claim 8, wherein each of the head wrap pins is formed from aluminum.

14. The cleaning tape cartridge of claim 8, wherein at least one of the head wrap pins includes a sleeve secured about a central shaft.

15. A method of cleaning a read/write head of a tape drive, the method including:
providing a cleaning tape cartridge including a housing, at least one tape reel and a cleaning tape;
inserting the cleaning tape cartridge into the tape drive such that the head engages the cleaning tape at a nominal head wrap angle of at least 14.0°; and
driving the cleaning tape across the head such that the cleaning tape contacts and removes debris from the head, thereby cleaning the head.

16. The method of claim 15, wherein the head engages the cleaning tape at a nominal head wrap angle of approximately 17.5°.

17. The method of claim 15, wherein the head includes a central region and opposing outer regions, and further wherein inserting the cleaning cartridge includes:
orientating the cleaning tape relative to the head such that the cleaning tape contacts at least a portion of the outer regions of the head.

18. The method of claim 15, further including:
programming the tape drive to develop a slack in the cleaning tape, whereby the slack wraps about at least a portion of the head.

19. The method of claim 15, further including:
programming the tape drive to move the head forward relative to the cleaning tape to achieve the nominal head wrap angle of at least 14.0°.

20. The method of claim 15, wherein providing the cleaning tape cartridge includes forming the cleaning tape cartridge to include first and second tape reels and first and second head wrap pins disposed within the housing, the tape reels maintaining the cleaning tape and the head wrap pins being configured to position the cleaning tape across a head access window, and further wherein the head wrap pins direct the cleaning tape to the nominal head wrap angle of at least 14.0° with the head following insertion of the cleaning tape cartridge.

21. The method of claim 20, wherein the head wrap pins are movable within the housing, the method further including:
moving the head wrap pins following insertion of the cleaning tape cartridge into the tape drive, wherein movement of the head wrap pins directs the cleaning tape to wrap about the head.

22. The method of claim 15, wherein providing the cleaning tape cartridge includes forming the cleaning tape cartridge to include a single tape reel.
